(19) United States
(12) Patent Application Publication
(10) Pub. No.: US 2010/0056116 A1
(43) Pub. Date: Mar. 4, 2010

(54) METHOD AND SYSTEM FOR DISPLAYING INFORMATION COLLECTED BY PORTABLE TERMINALS

(75) Inventors: Jae Ho Kim, Hwaseong-si (KR); Yoo Mi Noh, Suwon-si (KR); Jay Han, Anyang-si (KR); Jong Sun Pyo, Suwon-si (KR)

Correspondence Address: CHA & REITER, LLC, 210 ROUTE 4 EAST STE 103, PARAMUS, NJ, 07652, US

(73) Assignee: Samsung Electronics Co.LTD., Gyeonggi-Do (KR)

(21) Appl. No.: 12/552,383

(22) Filed: Sep. 2, 2009

(30) Foreign Application Priority Data
Sep. 2, 2008 (KR) 10-2008-0086390

(51) Int. Cl. H04M 3/42; G01C 21/00

(52) U.S. Cl. 455/414.1; 701/208; 455/566

(57) ABSTRACT

A method and system for displaying information collected by a portable terminal, wherein the portable terminal collects a variety of information according to the use of a message transmission/reception function, a call function, and a camera function, and displays it on a map information image. The portable terminal collects activity information and environmental information, determines an external environment and a type of movement of the portable terminal, and displays them together with an icon or image according to the message transmission/reception function, the call function, and the camera function. The environmental information may also be displayed as a background image when sending or receiving calls.

### CLAIM OF PRIORITY

This application claims priority from an application entitled “METHOD AND SYSTEM FOR DISPLAYING INFORMATION COLLECTED BY PORTABLE TERMINALS” filed in the Korean Intellectual Property Office on Sep. 2, 2008 and assigned Serial No. 10-2008-0086390, the contents of which are incorporated herein by reference in its entirety.

### BACKGROUND OF THE INVENTION

1. Field of the Invention

The present invention relates to displays of portable terminals. More particularly, the present invention relates to a method and system that displays a variety of information collected by a portable terminal at the same time.

2. Description of the Related Art

In recent years, portable terminals are in widespread use since the terminals can allow users to make a call with other parties when they are commuting, traveling, etc. Portable terminals are quickly becoming a necessary part of everyday life, and not a luxury item. As technology related to portable terminals continues to be developed, portable terminals have become smaller in size over time, yet provide increased functionality over time as well. In addition, with the development of various materials, a battery typically installed in the portable terminals has an increased capacity, so that portable terminals can now be operated for relatively longer periods of time than known heretofore.

In addition to providing a service wherein portable terminal users can send or receive a call while in motion, portable terminals now contain a variety of devices, such as a camera, an MP3 player, etc., in order to provide additional services to users.

In particular, the advanced development of memory technology and CPU related technology for operating the memory permits the portable terminals to be smaller in size and provides a larger memory space, so that they can store a relatively large amount of data and process the data at a high rate. It is desirable to develop a variety of services based on the present day memory technology and CPU related technology.

### SUMMARY OF THE INVENTION

The present invention provides a system that collects information, generated while a user operates a portable terminal, and mixes up the collected information on the map information image as a type of informational montage, so that it can serve as a storage device that stores and displays information regarding a user's portable terminal history and can also allow the user to efficiently search for corresponding data.

The present invention further provides a method that collects information, generated while a user operates a portable terminal, and mixes the collected information on the map information image, so that it can store and display information regarding a user's portable terminal history and can also allows the user to efficiently search for corresponding data.

In accordance with an exemplary embodiment of the present invention, a method for displaying information collected by a portable terminal, includes: activating at least one of the message transmission/reception function, call function, and camera function in the portable terminal; and displaying an icon or image corresponding to the activated function on a map information image showing a current location of the portable terminal.

In accordance with another exemplary embodiment of the present invention, a system for displaying information collected by a portable terminal, includes: a storage unit for storing map information; a display unit for displaying the map information; a location information collecting module for collecting location information regarding the portable terminal displayed on the map information image; and a controller for controlling an icon or image corresponding to a camera function on the map information image displayed on the display unit, based on the location information.

In accordance with still another exemplary embodiment of the present invention, a system for displaying information collected by a portable terminal, including: a storage unit for storing map information; a display unit for displaying the map information; a location information collecting module for collecting location information regarding the portable terminal displayed on the map information image; and a controller for controlling an icon or image corresponding to a call function on the map information image displayed on the display unit, based on the location information.

In accordance with yet another exemplary embodiment of the present invention, a system for displaying information collected by a portable terminal, includes: a storage unit for storing map information; a display unit for displaying the map information; a location information collecting module for collecting location information regarding the portable terminal displayed on the map information image; and a controller for controlling an icon or image corresponding to a message transmission/reception function on the map information image displayed on the display unit, based on the location information.

### BRIEF DESCRIPTION OF THE DRAWINGS

The features and advantages of the present invention will become more apparent to a person of ordinary skill in the art from the following detailed description in conjunction with the accompanying drawings, in which:

FIG. 1 is a schematic block diagram illustrating a portable terminal according to an exemplary embodiment of the present invention;

FIG. 2 is a view illustrating a screen showing a background when a text message is stored in a portable terminal according to an exemplary embodiment of the present invention;

FIG. 3 is a view illustrating a screen for storing an image taken by a camera stored by using another portable terminal user's information, according to an exemplary embodiment of the present invention;

FIG. 4 is a view illustrating a map on which a variety of icons and images are displayed, according to an exemplary embodiment of the present invention; and

FIG. 5 is a flow chart describing exemplary operation of a method for displaying information collected by a portable terminal on the display unit of the portable terminal.

### DETAILED DESCRIPTION

Hereinafter, exemplary embodiments of the present invention are described in detail with reference to the accompanying drawings. Detailed descriptions of well-known functions and structures incorporated herein may be omitted to avoid obscuring appreciation of the subject matter of the present invention by a person of ordinary skill in the art.

Prior to explaining the exemplary embodiments of the present invention, terminologies will be defined for the present description below hereinbelow. The terms or words described in the present description and the claims should not be limited by a general or lexical meaning, instead should be analyzed as a meaning and a concept through which the inventor defines and describes the present invention at his best effort, to disclose the best mode of the present invention. Therefore, one skilled in the art will understand and appreciate that the examples disclosed in the description and configurations illustrated in the drawings are only preferred exemplary embodiments, and there may be various modifications, alterations, and equivalents thereof to replace the exemplary embodiments at the time of filing this application that are within the spirit and scope of the appended claims.

For example, in an exemplary embodiment of the present invention, although a short-range radio frequency (RF) communication module is explained based on a Bluetooth (BT) module, it should be understood that the present invention is not limited to the aforementioned example. It will be appreciated that the short-range RF communication module according to the present invention may be implemented, for example, with a Zigbee communication module, a UWB communication module, etc., just to name a few possibilities. In addition, although location information regarding a portable terminal is acquired via a global positioning service (GPS) unit in an exemplary embodiment of the present invention, it should be understood that the present invention is not limited to the exemplary embodiment shown and described herein. It will be appreciated that location information regarding a portable terminal can also be acquired thorough a plurality of base stations, for example.

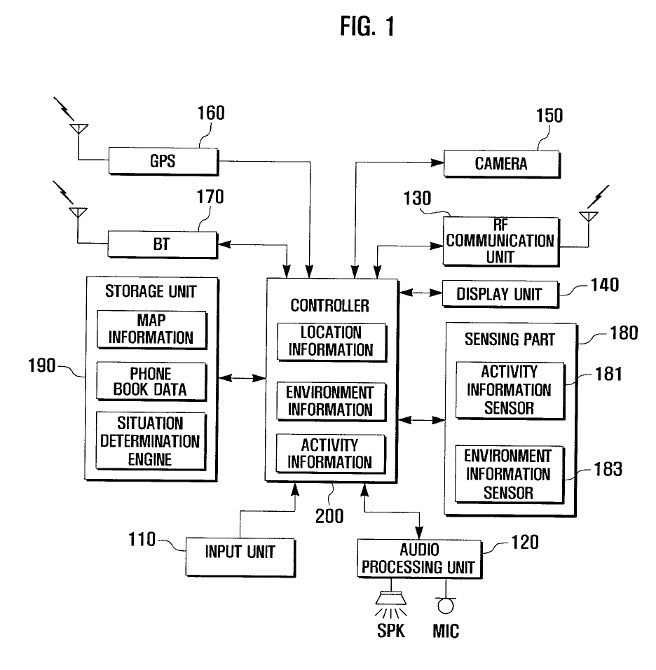

FIG. 1 is a schematic block diagram illustrating a portable terminal according to an exemplary embodiment of the present invention.

Referring now to FIG. 1, the exemplary portable terminal shown includes an input unit 110, an audio processing unit 120, an RF communication unit 130, a display unit 140, a camera 150, a global positioning service (GPS) unit 160, a short-range RF communication module 170 (such as a Bluetooth (BT) module), a sensing part 180, a storage unit 190, and a controller 200.

The portable terminal operates the RF communication unit 130, the audio processing unit 120, the GPS unit 160, the camera 150, the sensing part 180 and the BT module 170 to sort collected information according to a certain format, mixes up the sorted information on a map information image, stored in the storage unit 190, and displays it on the display unit 140. That is, the portable terminal displays a variety of information on a map information image that is displayed on the display unit 140, so that the portable terminal user can intuitively and efficiently trace back in his/her memory when, where and what happened, and can also monitor the progress procedure of his/her job, through the variety of information displayed on the display unit 140. In the following description, respective elements are explained in detail.

The input unit 110 preferably includes a plurality of keys and function keys for inputting numerical and alphabetical information and setting a variety of functions. The function keys include, for example, direction keys, side keys and short-cut keys, etc. which are set to activate particular functions in the portable terminal. The input unit 110 generates key signals related to a user's setting and function controls and outputs them to the controller 200. In particular, in an exemplary embodiment of the present invention, the input unit 110 can generate an input signal for activating a display of map information on the display unit 140, an input signal for enabling a monitoring function to mix up collected information to form a map information image, an input signal for providing selective storage or deletion of pieces of information displayed on the map information image, an input signal for controlling camera operation, an input signal for making a call, etc., according to a user's input operation, and can output these signals to the controller 200.

The audio processing unit 120 preferably includes a speaker SPK and a microphone MIC. The speaker SPK reproduces audio data transmitted or received via the RF communication unit 130, during a voice or video call. On the other hand, the microphone MIC receives a user's voice or other audio sounds during a voice or video call. The audio processing unit 120 can generate, for example, an alarm signal during the process of mixing up collected information on the map information image after the map information is displayed on the display unit 140. The audio processing unit 120 can also, for example, preferably reproduce a recorded audio signal to output a voice via the speaker, according to a user's setting.

Still referring to FIG. 1, the RF communication unit 130 transmits or receives a voice or video signal to/from a base station during the call and outputs the signal to the controller 200. To this end, the RF communication unit 130 is configured to include an RF transmitter for up-converting the frequency of transmitted signals and amplifying the transmitted signals, and an RF receiver for low-noise amplifying received RF signals and down-converting the frequency of the received RF signals. In particular, in an exemplary embodiment of the present invention, call connection information of the RF communication unit 130 includes information regarding a call connection time, which is generated when a call is connected, and a call releasing time when the call connection is released. The call connection information also includes information regarding voice sounds recorded during the call according to a user's setting. The controller 200 collects this information and applies it to the map information image.

The display unit 140 displays screens according to a variety of pre-programmed or requested functions of the portable terminal, for example, a standby screen, a menu screen, a file reproduction screen, a call screen, etc. The display unit 140 can display an image, which is collected by the camera 150 and whose size is adjusted, in a particular position on the map information image. The display unit 140 is implemented with an LCD. In the case where the display unit is implemented with an LCD, the display unit 140 includes an LCD controlling unit, a memory for storing data, and an LCD panel. In particular, if the LCD is implemented with a touch screen, the display unit 140 can also serve as an input device. In an exemplary embodiment of the present invention, the display unit 140 displays map information, stored in the storage unit 190, according to a user's selection or setting. The display unit 140 also displays a mashup image as collected information is mashed up with the map information image. The display unit 140 can display images collected by the camera 150 in a preview image format, and, if a particular image is selected, can also display the image over the entire screen. The screen interface of the display unit 140 will be explained, in detail, later, with reference to the accompanying drawings.

The camera 150 collects images through the lens according to a user's input signal and outputs the collected images to the display unit 140 through the controller 200. To this end, the camera 150 includes a camera sensor for sensing an optical signal corresponding to an object received through the lens and converting the optical signal into an electrical analog signal, and a signal processing unit for converting the analog electrical signal into a digital signal. In an exemplary embodiment of the present invention, the camera sensor may be implemented with a charge coupled device (CCD) sensor, and the signal processing unit may be implemented with a digital signal processor (DSP). It should be, however, understood that the present invention is not limited to this exemplary embodiment. In particular, in another exemplary embodiment of the present invention, the controller 200 receives images collected by the camera 150, adjusts the size of the images, and then outputs the size-adjusted images on the display unit 140, together with a map information image.

The global positioning service (GPS) unit 160 collects information regarding a location where a portable terminal is currently located, according to the control of the input unit 110, and then outputs it to the controller 200. The GPS unit 160 can be operated to acquire information regarding a user's location. The GPS unit 160 can be automatically operated while a monitoring function is being performed, i.e., map information is being displayed on the screen and location information regarding the portable terminal is also displayed thereon. That is, while map information is being displayed on the display unit 140, the GPS unit 160 periodically collects location information regarding a portable terminal and outputs it to the controller 200. If a particular function is activated in the portable terminal, the GPS unit 160 collects location information regarding the portable terminal and outputs it to the controller 200. Examples of the particular function are an image collecting function of the camera 150, a call function, a message transmission/reception function, a function of a BT module 170, etc.

The BT module 170 employs in this particular example Bluetooth, which is a standard for radio frequency (RF) communication regarding short-range, one-to-many, and voice, and data communication. Bluetooth allows for communication through solid materials other than metal. The BT module 170 can typically allow for communication between devices in a range of 10 cm˜10 m, but can extend the communication range up to 100 m if electromagnetic wave power is increased. The BT module 170 preferably operates in the 2.402 to 2.480 GHz range of 2.4 GHz band (the 2.4 GHz band is also called industrial-scientific-medial (ISM) band) and a transfer rate of 1 Mbps, according to a frequency hopping method to avoid interference (79/23 hops, 1600 hops/sec). The BT module 170 consumes a relatively low amount of electric power (0.3 mA in a standby state and maximum 30 mA in a transmission and reception) and has a transmission distance of 10 m (100 m, optional). In particular, in an exemplary embodiment of the present invention, if the portable terminal uses a variety of functions, for example, an image collecting function, a call function, a message transmission/reception function, etc., the BT module 170 is activated according to the control of the controller 200 and scans and detects whether an electronic device using another BT module exists. If the electronic device using another BT module scans the portable terminal, identification information regarding the other BT module can be transmitted to the controller 200. The controller 200 can add the information collected by the BT module 170 to an icon that is displayed on the map information image according to the use of another function. That is, if a user activates an icon displayed on the map information image, the controller 200 can include information regarding a BT module in the icon, where the information is related to the portable terminal user and exists in the vicinity of the icon when information related to the icon is generated. A connection with the portable terminal user can be established as the portable terminal user previously registers the electronic device having a BT module to the portable terminal. If there is no information regarding a BT module, the controller 200 does not add any information to a corresponding icon.

In an exemplary embodiment of the present invention, while the short-range RF communication module explained above is based on a BT module, it should be understood that the claimed invention is not limited to the exemplary embodiment. For example, the short-range RF communication module can also be implemented with other types of communication module that supports communication protocols including but in no way limited to, for example, Zigbee communication, ultra-wide band (UWB) communication, infrared (IR) communication, etc., the inventors find it preferable to use a BT module considering the rate of propagation.

The sensing part 180 includes an activity information sensor 181 and an environmental information sensor 183. The activity information sensor 181 senses information that is related to the motion of a portable terminal. The environmental information sensor 183 senses information regarding an external environment of a portable terminal. The activity information sensor 181 includes an acceleration sensor for detecting movement acceleration of a portable terminal, a direction sensor for detecting direction, etc., a vibration sensor for detecting vibration, and a gyro sensor. The environmental information sensor 183 includes a variety of sensors for detecting ambient states of a portable terminal, for example, a temperature sensor for detecting temperature, a humidity sensor for detecting humidity, a human body temperature sensor for detecting the portable terminal user's body temperature, a blood pressure sensor for measuring the portable terminal user's blood pressure, an illuminance sensor, etc. The sensing part 180 collects activity information and environmental information and outputs them to the controller 200.

The storage unit 190 stores application programs for operating the portable terminal and the elements, such as the GPS unit 160, BT module 170, camera 150, sensing part 180, etc. The storage unit 190 also stores a variety of data generated as the application programs are executed. The storage unit 190 can serve as a buffer of a certain capacity that buffers data and video information when a call function is performed and the camera 150 is operated. The storage unit 190 is configured to include a program area and a data area.

The program area stores an operating system (OS) for booting the portable terminal, an application for operating the camera 150 and collecting audio sounds, an application program for operating the GPS unit 160, a Bluetooth application program, and a sensor application program such as drivers for controlling the plurality of sensors. The program area also stores application programs for operating other optional functions, such as, for example, an audio sound reproduction function, an image or moving image reproduction function, etc., just to name a few possible examples. The program area includes a situation determining engine programmed with an algorithm for predicting a current state of the portable terminal using a variety of components. The situation determining engine predicts an external environment of the portable terminal by the use of a variety of information collected by the portable terminal, such as, activity information, environmental information, location information, map information, etc., and then outputs the predicted information to the controller 200. When the portable terminal activates a corresponding function in response to a user's request, the controller 200 executes an application program corresponding thereto so that it provides a corresponding service to the user.

The data area stores data generated as the portable terminal is used and map information. For example, the data area stores data corresponding to an image selected from among images captured by the camera 150, transmitted/received data according to the activation of the BT module 170, location information collected as the GPS unit 160 is activated, activity information and environment information from the sensing part 180, predicted information as a result of predicting a current situation of the portable terminal, etc. The data area can also store user data related to a variety of optional functions provided by the portable terminal. Some possible examples of the user data can be that of moving images, phone book data, audio data, contents, and information corresponding to user data. The data area can store data generated as communication is performed via the RF communication unit 130, for example, messages, call log information, stored voice or information regarding the stored voice during the call, and video information during the video call.

The controller 200 controls the booting process of the portable terminal when the portable terminal is switched on. In other words, the controller 200 preferably supplies electric power to respective elements according to a user's setting, and initializes the elements. The controller 200 controls transmission of information among elements to support a monitoring function and also controls activation of the elements. The controller 200 also performs a control operation to display map information, stored in the storage unit 190, on a standby screen according to a user's setting, or to switch a standby screen to a screen for displaying map information according to user input. After that, the controller 200 activates the GPS unit 160 to collect location information and displays a current location of the portable terminal on a map information image based on the collected location information. The controller 200 displays map information regarding a local area, where the portable terminal is approximately located, on a screen, based on the location information collected via the GPS unit 160, and then designates a location of the portable terminal on the map information image.

When a message is transmitted or received, in an exemplary embodiment of the invention, the controller 200 can display a location where the message is transmitted from or received to on the map information image. The controller 200 can also display an icon corresponding to the location where the message is transmitted or received on the map information image, so that a user can intuitively recognize the location on the screen displaying the map information image. The controller 200 can apply environment information to the message in order to store it, which will be described in detail, later, with reference to the accompanying drawings.

If a call function is activated, the controller 200 preferably collects location information at the point in time point in which the call function is activated, and displays an icon corresponding to the call function on a corresponding position of the map information image. Since the call function is performed for a certain time period, the controller 200 collects at least one piece of location information corresponding to the time point the call starts and the time point the call is terminated and then displays a corresponding location on the map information image. When the portable terminal is moved during the call, the controller 200 displays the moved path on the map information image.

The controller 200 collects activity information using the sensing part 180 and applies the collected activity information to the map information image. For example, the controller 200 detects movement acceleration and direction of the portable terminal using the acceleration sensor, vibration sensor, and direction sensor. The controller 200 can also predicts a moving means (i.e. the type of movement) of the portable terminal, based on information regarding the detected movement acceleration and direction, using the situation determining engine. The situation determining engine compares the acceleration information and direction information with a preset reference value and determines whether the portable terminal is being moved by a portable terminal user's movement on foot or by other traffic means. The traffic means may be a bus, a motorcycle, a bicycle, a train, etc. If the controller 200 ascertains the portable terminal is moved via any other type of traffic means based on the acceleration information and direction information, it activates a pop-up window so as to allow a user to select one of the traffic means or selects a preset traffic means as a default. Through the process described herein above, the controller 200 applies activity information of the portable terminal to the map information image and then displays it on the screen. The controller 200 collects environmental information using the sensing part 180, and applies it to a message icon, according to a message transmission/reception function, and a call icon, according to a call function, which are preferably displayed on the map information image. More specifically, the controller 200 provides date information and environmental information, collected by, for example, a temperature sensor, a humidity sensor, and an illuminance sensor, to the situation determining engine. The situation determining engine predicts weather using the collected environment information and date, which is called season information. That is, the situation determining engine predicts whether the current weather is clear, raining, humid, snowing, etc., using the environment information, or the season information, and then outputs the predicted weather information to the controller 200. The controller 200 can set the predicted weather information as a background screen of the message to be stored. The controller 200 can also display an icon indicating a particular type of weather, together with a message icon and a call icon, displayed on the map information image.

According to an exemplary aspect of the present invention, the environmental information can be applied to the case where the camera is operated. That is, when the camera 150 of the portable terminal collects images, the controller 200 preferably displays an icon corresponding to an image collection on the map information image. During this process, the controller 200 can also display both a camera icon and an icon corresponding to the predicted weather information on the map information image.

The controller 200 operates the BT module 170 to detect whether or not other electronic devices related to the portable terminal are located in the vicinity of the portable terminal. and displays the identified information on the map information image together with other icons, such as a message icon, a call icon, a camera icon, etc. The electronic devices related to the portable terminal may be devices that include a BT module that is registered to the portable terminal. For example, regarding friends or family members, etc., the respective users link a BT list of their friends or family members together with their phone book data and then store it. That is, the portable terminal scans its ambient electronic devices, and detects electronic devices storing phone book data, from among the scanned electronic devices including a BT module, where the phone book data may contain photographs and names of friends and family members. The controller 200 operates the BT module 170 to scan its ambient electronic devices. If the controller 200 detects electronic devices related to itself, it displays the phone book information related to the detected electronic devices on the map information image together with icons.

As described above, since the system according to the present invention can display a plurality of icons associated with the functions of the portable terminal on the map information image, the portable terminal user can intuitively recognize when actions have occurred from glancing at the display. In addition, since the system according to the present invention can display icons on the map information image, together with ambient situations of the portable terminal or information regarding the state of the portable terminal, the portable terminal user can acquire a variety of information.

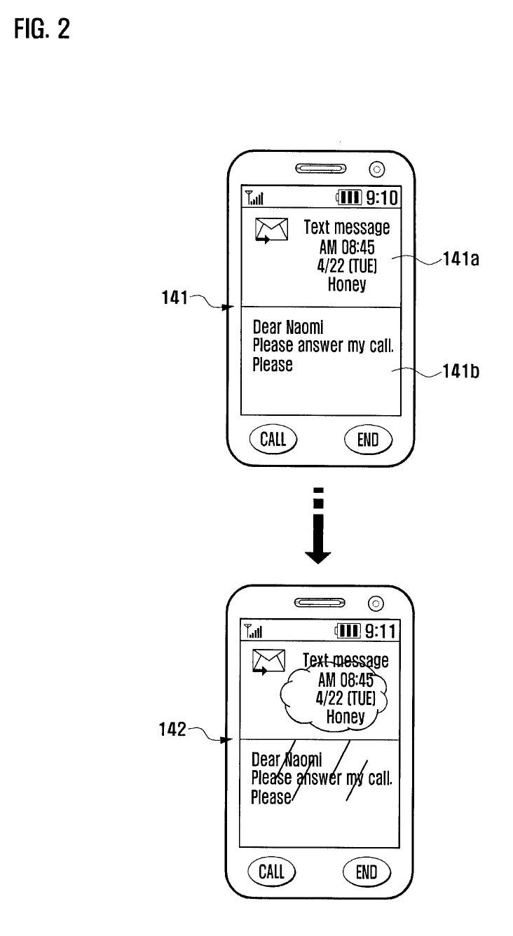

FIG. 2 is a view illustrating a screen for displaying a message, to which environment information is applied to, according to another exemplary embodiment of the present invention.

Referring now to FIG. 2, when the portable terminal receives a message, the display unit displays the first area screen 141 that includes the first area 141a and the 12^{th} area 141b. The first area 141a displays a message receiving time and the date and name of a message sender. The second area 141b displays the content of the received message. If a monitoring function is activated, the controller activates the environment information sensor to collect environment information and outputs the collected environment information to the situation determining engine. When the controller receives predicted information regarding an external environment of the current portable terminal from the situation determining engine, it can select a background screen corresponding to the predicted information. To this end, the portable terminal has previously stored background screens corresponding to a variety of predicted information that can be predicted by the situation determining engine, respectively.

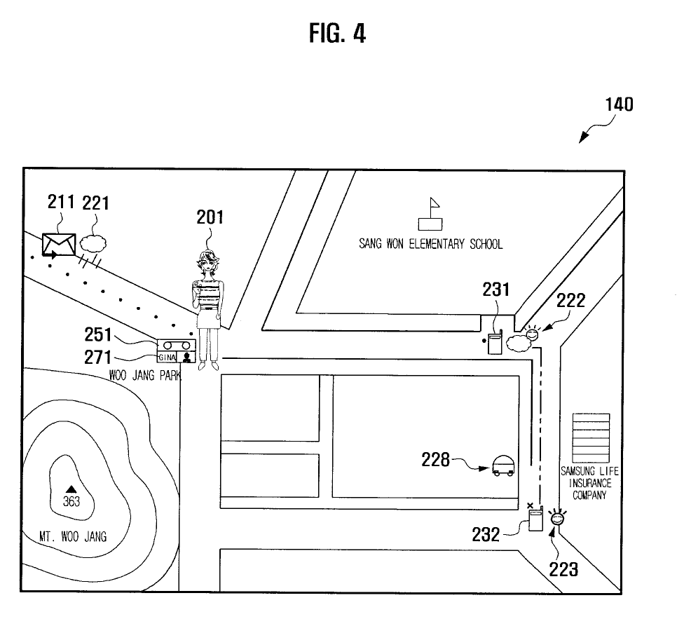

The controller applies a corresponding background screen to the background screen of the first area screen 141 and thus generates the second area screen 142. After that, when an input signal for storing a message is input, the controller can store a message having a background screen corresponding to the second area screen 142 in the memory. For example, if the situation determining engine ascertains that the external environment is rainy, the controller selects a background screen corresponding to the rainy environment and applies it to the second area screen 142, so that the message can be displayed on a rainy background screen. After the message has been stored, the controller switches the current screen to a screen displaying map information, which will be described later, in detail, with reference to FIG. 4.

Although the exemplary embodiment shown in FIG. 2 is explained based on a message, it should be understood that it can also be operated using the call function. For example, if the call function is activated, the controller can apply environmental information and a background screen determined by a situation determining engine to a call log stored in the storage unit, and can thus store it as a background screen of the call log. If a call log is displayed in one line, the controller can apply an icon, corresponding to the environmental information and the predicted information determined by the situation determining engine to a certain area of the call log.

Although the exemplary embodiment shown in FIG. 2 is explained based on a message reception, it can also be operated in a message transmission. That is, the controller determines a background screen using environmental information and the predicted information calculated by the situation determining engine. The determined background screen can be identically applied to operations where a transmission message is stored in the portable terminal and a message is received.

The controller can transmit a message, whose background screen is determined based on the predicted information, to another portable terminal. Therefore, the other portable terminal user receiving the message can recognize an external environment of the portable terminal transmitting the message through the received background screen. For example, if a calling portable terminal transmits a message to a called portable terminal in a rainy environment, the called portable terminal can receive a message with a rainy background screen applied, even if the recipient terminal happens to be located in a sunny environment, or located in an indoor environment where the weather is unknown.

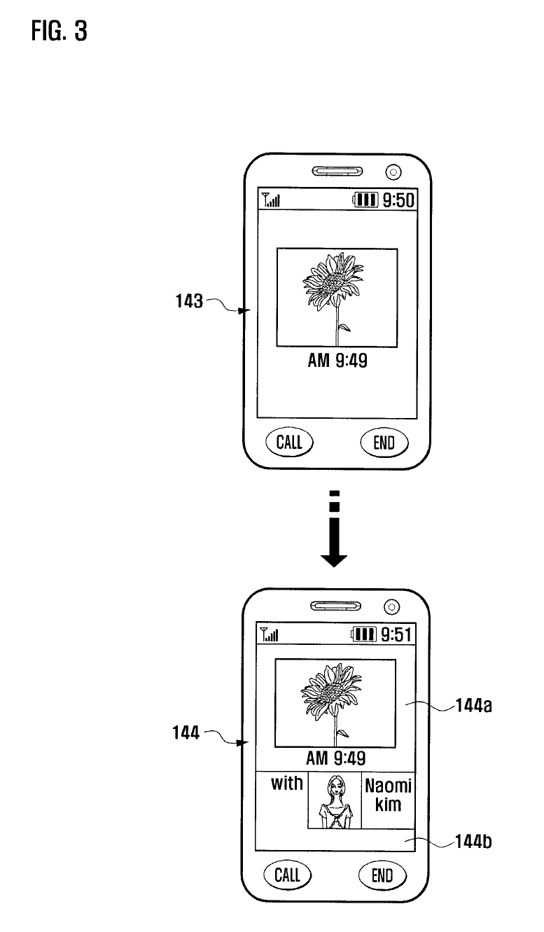

FIG. 3 is a view illustrating a screen when a camera and a BT module are operated in a portable terminal, according to an exemplary embodiment of the present invention.

Referring now to FIG. 3, the controller activates a camera according to a user's input signal, and also displays currently captured images as a preview screen on the display unit according to a user's input signal. The portable terminal user inputs a signal for capturing an image, currently displayed on a preview screen, into the input unit so that it is output to the controller. The controller also controls image collection from the current preview screen, so as to capture an image, as shown in the 21^{st} screen 143, and then to display the captured image on the display unit.

According to an exemplary aspect of the present invention, the controller can activate the BT module and scan the peripheral electronic devices with a predetermined range of the portable terminal. If the controller detects an electronic device including at least one BT module that was registered in a BT list of the portable terminal, the controller then checks as to whether there is phone book data associated with the scanned BT list. The controller may search for a variety of information regarding electronic devices associated with a corresponding BT list from the phone book data associated with a BT list. Examples of the variety of information are photographs acquired by the portable terminal user, names input by the user, etc. If a photograph or a name is searched, the controller resizes an image displayed on the 21^{st} screen 143, then displays it on the 21^{st} area 144a of the 22^{nd} screen 144, and displays the searched photograph or name on the 22^{nd} area 144b.

Therefore, according to the present invention, the portable terminal user can store information regarding locations of electronic devices with a predetermined distance/or in communication with the portable terminal, as additional information regarding the currently captured photograph. The predetermined distance could be, for example a Bluetooth operable or extended range, or an RF communication distance between a plurality of devices, and for example, a base station. That is, the portable terminal user can store the captured image and a photograph or name. As described above with FIG. 2, the controller activates the environment information sensor to collect environmental information regarding the current external environment, and may output it to the situation determining engine, according to a user's setting. After that, the controller determines a background screen based on the predicted information from the situation determining engine and can apply it to a background screen for a captured image.

FIG. 4 is a view illustrating a map on which a variety of icons and images are displayed, according to an exemplary embodiment of the present invention.

Referring now to FIG. 4, the display unit 140 displays map information stored in the storage unit according to a user's setting. The controller activates the GPS unit to collect location information regarding a current location of the portable terminal and then displays the current location on the map information image. Displaying the current location of the portable terminal can be implemented by a user icon 201 corresponding to the portable terminal user. The user icon 201 can be replaced with other images according to a user's setting.

When a portable terminal user transmits/receives a message while moving, the controller displays a message icon 211 corresponding to a message transmission/reception function on the map information image. The controller collects environment information acquired by the environment information sensor and predicted information acquired by the situation determining engine and then determines a first background icon 221 based on the predicted information.

In this particular example, the first background icon 221 is similar to the background screen described above. For example, the first background icon 221 can be implemented to correspond to a variety of predicted information, respectively. To this end, it is preferable that the portable terminal stores background icons that correspond to a variety of predicted information, respectively. As described above, the display unit can display the message icon 211 corresponding to a message transmission/reception function and the first background icon 221 at the current location on the map.

Next, when the portable terminal user moves a certain predetermined distance to/at a particular location and then operates the camera at that location, the controller displays a camera icon 251 at the that position on the map. For example, if the portable terminal user operates the camera at Woo Jang Park and collects images, the controller displays the camera icon 251 at Woo Jang Park on the map. During this process, the controller operates the BT module to detect whether another portable terminal is within a predetermined communication range of the portable terminal user. If the controller ascertains that another portable terminal exists with range, the controller checks whether or not to store information regarding the other portable terminal. When the controller stores a name or a photograph corresponding to the other portable terminal, the controller causes the display to display the camera icon 251 and the BT module icon 271 on the map, together. The BT module icon 271 may not be displayed on the map if there is no other scanned portable terminal within communication range of the portable terminal user. For example, it is assumed that two friends possess portable terminals, respectively, which share a BT list and include phone book information regarding the BT list. If they visit ‘Woo Jang Park’ and friend 1 operates a camera to collect images, the controller of the friend 1's portable terminal operates the BT module can scan friend 2's portable terminal. If the controller of friend 1's portable terminal ascertains that friend 2's portable terminal includes a previously stored BT list and information regarding friend 2's photograph or name as phone book data corresponding to the BT list, it displays the camera icon 251 and the BT icon 271 on the display unit. The BT icon 271 may be a previously set image, an image generated by resizing friend 2's photograph, or friend 2's name.

Next, if a portable terminal user rides a bus at ‘Woo Jang Park,’ the controller activates an activity information sensor to collect activity information regarding the portable terminal. The controller outputs the activity information, i.e., information sensed by the acceleration sensor, direction sensor, and vibration sensor, to the situation determining engine. The situation determining engine predicts a type of movement for the portable terminal user by the use of the activity information from the acceleration sensor and the direction sensor. For example, if the situation determining engine detects that the portable terminal is moved less than a certain velocity and a vibration occurs, it ascertains that the portable terminal user is walking. If the situation determining engine detects that the portable terminal is moved greater than a certain velocity and no vibration occurs, it ascertains that the portable terminal user is moving by bus or by subway train. Since the vibration sensor can detect vibrations that may be generated by a bus or subway train, if more than a certain number of vibration occurs, it is preferable that the situation determining engine can distinguish between bus or subway vibrations and the vibrations association with walking (caused by, for example, footsteps).

As described above, when the situation determining engine outputs the predicted information regarding a type of movement for the portable terminal to the controller, the controller can differentiate displays images corresponding to respective types of movement on the map information image. For example, if a portable terminal user walks from a start point to ‘Woo Jang Park,’ the controller displays a dotted line image tracking the movement on the map information image. If a portable terminal user moves by bus from ‘Woo Jang Park’ via ‘Sang Won elementary school’ to ‘Samsung Life Insurance Company’, the controller displays a solid line image along the bus trajectory. An icon corresponding to the type of movement, for example a bus icon 228, can be displayed for at least one of the start point and the end point of the solid line.

While the portable terminal user is traveling by bus, if he/she uses a call function at ‘Sang Won elementary school’, the controller displays an icon corresponding to the call function, i.e., a first call icon 231, at a corresponding position on the map. As described above, the controller can also display the background icon 222, predicted by the environmental information and the situation determining engine, beside the first call icon 231. Afterwards, the controller can display a 2^{nd} call icon 232 at a place where the call function has been completed, i.e., a place passed by after ‘Samsung Life Insurance Company’ on the map. The controller can also display a particular image on the path between the 1^{st} call icon 231 and the 2^{nd} call icon 232, for example a two-dotted chain line, on the map, so as to show how long the call function is enabled from a start point to the end point. Similar to the case of the 1^{st} call icon 231, the background icon 223 is also displayed beside the 2^{nd} call icon 232 displayed at the end of the call. It is preferable to display the 1^{st} call icon 231 and the 2^{nd} call icon 232 in different images so that the users can recognize a call start and a call termination.

The sensing part can periodically sense ambient situations in an exemplary embodiment of the present invention. It is, however, preferable that only sensors in the sensing part be activated periodically in order to save battery energy. That is, the controller first operates the acceleration sensor, the vibration sensor and the direction sensor, included in the activity information sensor, and then activates the acceleration sensor if no vibration occurs to detect whether activity information regarding the portable terminal is changed. It is preferable that the environmental information sensor first activates the temperature sensor and then operates other sensors, such as a humidity sensor, if temperature is deviated from a certain range.

In an exemplary embodiment of the present invention, although the display unit displays a map information image in a fixed manner, it should be understood that the map information image can be refreshed (periodically or upon change or request) so as to move the position of the user icon 201 to the center of the display unit.

As described above, the system for displaying information collected by a portable terminal, according to an exemplary embodiment of the present invention, performs a control operation to display a variety of functions, used by the portable terminal user during his/her movement of activity, on a map, and thus allows the portable terminal user to monitor how his/her daily progress. Furthermore, the information displaying system can store collected information by dates or by times, so that the portable terminal user can easily trace in his/her memory where and when he/she used the portable terminal and what portable terminal function he/she used.

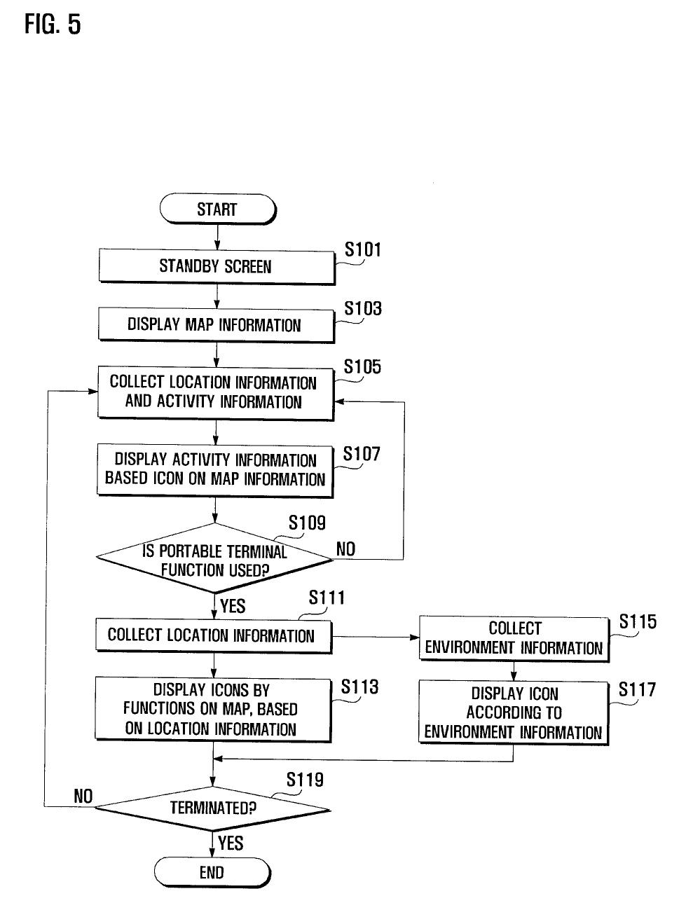

In the foregoing description, the configuration and screen interface of the system for displaying information collected by the portable terminal were explained. In the following description, a method for displaying information collected by the portable terminal is explained in detail with reference to FIG. 5.

FIG. 5 is a flow chart describing exemplary operation of a method for displaying information collected by a portable terminal on the display unit of the portable terminal according to the present invention.

Referring now to FIG. 5, when the portable terminal is switched on, the controller performs a booting operation. After that the controller preferably displays a preset standby screen on the display unit (101).

The controller controls the display unit to display map information stored in the storage unit (103). To this end, the controller operates the GPS unit to collect information regarding a current location of the portable terminal. It is preferable that the controller displays a map corresponding to the collected current location information regarding the portable terminal on the display unit. The map information image displayed on the display unit refers to a certain area including information regarding the current location of the portable terminal.

After that, the controller collects location information and activity information (105). That is, the controller collects activity information regarding the portable terminal using the activity information sensor. The activity information sensor may include an acceleration sensor, a direction sensor, a vibration sensor, a gyro sensor, etc. The activity information includes acceleration information, direction information, vibration information, etc.

After collecting the activity information at 105, the controller displays an icon on the map information image, based on the location information and the activity information (107). To this end, the controller can provide the activity information to the situation determining engine. The situation determining engine generates predicted information regarding a type of movement for the portable terminal, for example, walking, by bus, etc., by the use of the activity information received from the controller, and then outputs it to the controller. The controller determines an icon or image corresponding to the predicted information from the situation determining engine.

For example, if the predicted information corresponds to walking, the controller then displays a movement path of the portable terminal on the map information image in a dotted line. If the predicted information corresponds to movement by bus, the controller displays the movement of the portable terminal on the display unit in a solid line. Furthermore, the controller displays an icon corresponding to a bus at least one of the start point and the end point of the solid line. Thus, the type of movement is differentiated in the display.

After the activity information is displayed based on icon map information, the controller determines at (109) whether or not a function of the portable terminal is used (109). The function may be, for example, a message transmission/reception function, a call function, a camera function, a BT function, etc.

If at step (109), the controller ascertains that a function of the portable terminal is not used, the controller returns to and proceeds with step (105), where location information and activity information are collected and then applied to the map information. Operating the activity information sensor and applying information to a map information image can be performed irrespective of the user of the portable terminal function.

On the contrary, if the controller ascertains that a function of the portable terminal is used at step (109), the controller collects location information (111) and displays icons by portable terminal functions on the map according to the location information (113). After that, the controller collects environmental information (115) and displays location information and icons according to the environment information on the map (117).

As described above, when a message transmission/reception function is used, the controller displays a message icon corresponding to the message transmission/reception function on a location corresponding to the collected location information on the map. The controller collects environmental information using the environment information sensor, outputs it to the situation determining engine, and collects predicted information regarding the current situation. The controller determines a background icon based on the predicted information and displays the background icon and the message icon at a position corresponding to the location information on the map information image. When the received receive message is stored or a message to be transmitted is written or stored, the controller selects a background screen, determined by the predicted information, and then stores it as a message having the selected background screen in the storage unit. To this end, the portable terminal can store background icons corresponding to pieces of predicted information, respectively, and a background screen.

When a camera function is used, the controller displays a camera icon corresponding to the camera function on a location corresponding to the collected location information on the map. The controller operates the BT module to determine whether, of the other portable terminals near the portable terminal, there is another portable terminal stored in a BT list of the portable terminal. If the controller detects another portable terminal stored in the BT list of the portable terminal, it displays information regarding another portable terminal user, for example, a photograph or name, as a background icon, on the map information image displaying the camera icon. The controller can resize the size of the photograph to fit the size of camera icon and display it. The controller can also adjust the name to a certain size and length and display it.

When a call function is used, the controller displays a call icon corresponding to the call function on a location corresponding to the collected location information on the map. The controller displays at least one of the 1^{st} call icon corresponding to a call start and the 2^{nd} call icon corresponding to a call termination on the map. The controller can display a line between the 1^{st} and 2^{nd} call icons, for example, a two-dotted chain line, indicating that a call was maintained. Similar to the use of a message transmission/reception function, the controller collects environmental information using the environmental information sensor, outputs it to the situation determining engine, and collects predicted information regarding a current situation. After that, the controller determines a background icon by the use of the predicted information and displays the background icon and the 1^{st} or 2^{nd} call icon on a location corresponding to location information on the map information image. The controller stores a call log, according to a call, and the background icon determined by the predicted information.

Finally, the controller determines whether the use of a monitoring service is terminated (119). If the controller ascertains that a monitoring service is still used at 119, it then returns to and proceeds with step 105 to repeat the steps described above.

As described above, the method and system for displaying information collected by the portable terminal, according to an exemplary embodiment of the present invention, can display use history information regarding the portable terminal on a map, so that the portable terminal user can precisely review the portable terminal memory on the use history information and check whether corresponding data is stored.

Although exemplary embodiments of the present invention have been described in detail hereinabove, it should be understood that many variations and modifications of the basic inventive concept herein described, which may be apparent to those skilled in the art, will still fall within the spirit and scope of the exemplary embodiments of the present invention as defined in the appended claims.

What is claimed is:

1. A method for displaying information collected by a portable terminal, comprising:
activating at least one of a message transmission/reception function, call function, and camera function in the portable terminal; and
displaying an icon or image corresponding to the activated function on a map information image.

2. The method of claim 1, wherein, if the call function is activated, displaying an icon or image comprises at least one of the following:
displaying a 1^{st} call icon or image corresponding to a call start at a call start location on the map information image;
displaying, if the call has been completed, a 2^{nd} call icon or image corresponding to a call termination at a call termination location on the map information image; and
displaying a preset image on a path between the 1^{st} call icon and the 2^{nd} call icon on the map.

3. The method of claim 1, further comprising:
collecting, if the call function is activated, collecting environmental information regarding an external environment of the portable terminal using a environment information sensor that includes at least one of the temperature sensor, humidity sensor, and illuminance sensor;
determining the external environment of the portable terminal using the environmental information;
selecting an icon or image corresponding to the determined external environment; and
applying the selected icon or image to a call log generated according to the call function and storing it.

4. The method of claim 1, further comprising:
collecting environmental information regarding an external environment of the portable terminal using an environmental information sensor;
determining the external environment of the portable terminal using the environmental information; and
displaying an icon or image corresponding to the determined external environment, together with an icon or image that is displayed on the map information image by the use of at least one of the message transmission/reception function, call function, and camera function.

5. The method of claim 4, wherein collecting environmental information regarding an external environment is acquired from at least one of the temperature sensor, humidity sensor, and an illuminance sensor.

6. The method of claim 1, further comprising:
scanning a periphery of the portable terminal using a short-range radio frequency (RF) communication module;
collecting, if another portable terminal stored in the list of the portable terminal is scanned, user information regarding the other portable terminal; and
displaying an icon or image corresponding to the user information, together with an icon or image that is displayed on the map information image by the use of at least one of the message transmission/reception function, call function, and camera function of the portable terminal.

7. The method of claim 1, further comprising:
collecting activity information according to the movement of the portable terminal using an activity information sensor;
determining a type of movement by which the portable terminal moves based on the activity information; and
displaying an icon or image corresponding to the type of movement on the map information image corresponding to the movement path of the portable terminal, based on location information of the portable terminal.

8. The method of claim 7, wherein collecting activity information comprises collecting sensed information values using an acceleration sensor and a vibration sensor.

9. The method of claim 8, wherein determining a type of movement of the portable terminal comprises predicting the type of movement of the portable terminal based on the values sensed by the acceleration sensor and the vibration sensor.

10. The method of claim 9, wherein displaying an icon or image corresponding to the type of movement comprises displaying an icon or image corresponding to the type of movement of the portable terminal on the map information image based on the predicted type of movement and a value sensed by a direction sensor.

11. The method of claim 9, wherein displaying an icon or image corresponding to the type of movement of the portable terminal comprises at least one of the following:
displaying an icon or image corresponding to the type of movement of the portable terminal on a movement start place of the portable terminal by the type of movement on the map information image;
displaying an icon or image corresponding to the type of movement of the portable terminal on a movement termination place of the portable terminal by the type of movement on the map information image; and
displaying a preset image on a path between the movement start place and the movement termination place on the map information image.

12. The method of claim 1, further comprising:
periodically collecting a current location of the portable terminal and storing it together with map information stored in the storage unit.

13. The method of claim 1, further comprising:
collecting, if the message reception function is activated, environmental information regarding an external environment of the portable terminal using an environment information sensor;
determining the external environment of the portable terminal using the environmental information;
selecting a background screen corresponding to the determined external environment;
applying the selected background screen to a received message; and
storing the received message with the background screen.

14. The method of claim 1, further comprising:
collecting, if the message transmission function is activated, environmental information regarding an external environment of the portable terminal using an environmental information sensor;
determining the external environment of the portable terminal using the environment information;
selecting a background screen corresponding to the determined external environment; and
applying the selected background screen to a message to be transmitted.

15. The method of claim 1, further comprising:
scanning, if the camera function is activated, a periphery of the portable terminal using a short-range radio frequency (RF) communication module;
collecting, if another portable terminal stored in a list of the portable terminals is scanned, user information regarding said another portable terminal; and
storing an image or name corresponding to the user information together with images collected by the camera.

16. A system for displaying information collected by a portable terminal, comprising:
a storage unit for storing map information;
a display unit for displaying the map information;
a location information collecting module for collecting location information regarding the portable terminal for display on the map information image; and
a controller for controlling at least one of a message transmission/reception function, call function, and camera function of the portable terminal,
wherein the controller displays an icon or image corresponding to the activated function on the map information image on the display unit, based on the collected location information.

17. The system of claim 16, further comprising:
an activity information sensor that comprises at least one of an acceleration sensor, direction sensor, vibration sensor, and gyro sensor,
wherein the controller determines a type of movement of the portable terminal using information sensed by the activity information sensor, and displays an icon or image corresponding to the type of movement of the portable terminal on the map information image.

18. The system of claim 17, wherein the controller displays:
an icon or image on a movement start place of the portable terminal that is based on the type of movement;
an icon or image on a movement termination place of the portable terminal that is based on the type of movement; and
an image on a path between the movement start place and the movement termination place.

19. The system of claim 16, further comprising:
an environmental information sensor that comprises at least one of a temperature sensor, humidity sensor, and illuminance sensor,
wherein the controller determines an external environment of the portable terminal based on information sensed by the environmental information sensor, and displays an icon or image corresponding to the determined external environment, together with an icon or image corresponding to at least one of the message transmission/reception function, call function, and camera function of the portable terminal.

20. The system of claim 16, further comprising:
a short-range RF communication module,
wherein the controller scans a periphery of the portable terminal using the short-range RF communication module, collects user information regarding other portable terminal that is stored in the list of the portable terminal and scanned by the controller, and displays an icon or image corresponding to the user information, together with an icon or image that is displayed on the map information image according to the use of at least one of the message transmission/reception function, call function, and camera function of the portable terminal.
